(19) United States
(12) Patent Application Publication
(10) Pub. No.: US 2026/0268418 A1
(43) Pub. Date: Sep. 10, 2026

(54) SYSTEM AND METHOD TO DETECT MARINE ACTIVITIES

(71) Applicant: Logistics and Supply Chain MultiTech R&D Centre Limited, Pok Fu Lam (HK)

(72) Inventor: Yifan Zhang, Pok Fu Lam (HK)

(21) Appl. No.: 19/074,553

(22) Filed: Mar. 10, 2025

(51) Int. Cl. G06Q 50/02; G06N 3/0455; G06V 10/77; G06V 20/54

(52) U.S. Cl. CPC G06Q 50/02; G06N 3/0455; G06V 10/7715; G06V 20/54

(57) ABSTRACT

The present invention relates to a method for detecting a vessel engaging in illegal fishing. The method includes the steps of: receiving automatic identification system (AIS) data from transceivers of vessels; preprocessing the AIS data to generate a set of motion-related features; constructing one or more trajectory representations from the set of motion-related features; extracting one or more features from the one or more trajectory representations with an auto-encoder module; and selecting one or more random sample data for an Artificial Intelligence Engine for detecting a vessel engaging in fishing. The Artificial Intelligence Engine includes an unsupervised learning module for labeling the one or more trajectory representations into a plurality of labels; and a supervised learning module for generating a machine learning model for determining the vessel engaging in illegal fishing.

### TECHNICAL FIELD

This invention relates is an advanced and innovative semi-supervised model that leverages AIS data to detect fishing activities.

### BACKGROUND

Illegal fishing is a major concern that jeopardizes global fisheries, marine biodiversity, ecosystem balance, and fish populations. In Hong Kong, illegal fishing activities occur almost daily, severely impacting local fisheries resources and marine ecosystems [1]. According to the Fisheries Protection Ordinance, fishing using unregistered vessels and fishing at irregular hours in regulated areas in Hong Kong waters are considered as illegal fishing [1]. Therefore, monitoring fishing vessels and detecting their mobility patterns play a vital role in combating illegal fishing and hence preserving Hong Kong's marine ecosystem. The marine authorities worldwide have been proactively looking for ways to improve the timelessness and efficiency of the current manual pattern analysis process for better planning and resource allocation in combating illegal fishing in Hong Kong. To help marine authorities achieve this, it is desirable to develop an autonomous and intelligent approach tailored for Hong Kong that can effectively detect fishing activities.

Navigational systems were developed to monitor and track fishing vessels, and hence can be used to assist in combating illegal fishing activities. Currently, most navigational data come from the Automatic Identification System (AIS), which serves as a promising source of data for identifying, monitoring, and capturing vessel movements without radar detection [2]. It allows offshore equipment to exchange real-time information, which can be utilized as an effective tool to uncover hidden fishing mobility patterns with the assistance of AI algorithms [3]. Much effort has been dedicated to developing more advanced AI techniques for detecting fishing activities from AIS data. Arasteh S et al. [4] developed a fishing activity classification model based on convolutional neural networks (CNNs) for identifying offshore fishing patterns. The model was trained on the labeled dataset released by Global Fishing Watch (GFW) and validated by datasets from U.S. and Denmark. This model can compare actual fishing activity with what the vessel reports, determining whether a vessel was illegally fishing at a given time. De Souza et al. [5] proposed three methods for fishing activity detection based on gear type using AIS data. Each method was specialized for a specific vessel type and cannot be generalized to other circumstances. Unlike the approaches above, Martha Dais Ferreira et al. [6] put forward a semi-supervised methodology for fishing activity detection using streams of AIS data when there is a lack of labeled data. This approach combines unsupervised and supervised models to infer labels for each data point and perform point-based classification tasks on the expanded labeled dataset. It relies on a point-based classification model and conventional parameters (e.g., navigational information such as course over ground (COG), change of COG, speed over ground (SOG), and acceleration), which are computationally intensive and time-consuming.

Despite the prominent progress made in detecting vessel movement patterns, these approaches could not be implemented in Hong Kong due to the following reasons. Firstly, fishing vessels are not compulsory to turn on their AIS transceivers in Hong Kong waters. Secondly, the AIS information can be manipulated by fishing vessels in terms of a vessel's unique MMSI, COG, and SOG [7]. Lastly, AIS reports in Hong Kong lack a status field that indicates the vessel activity, such as fishing and sailing. These kinds of issues make it much easier for the fishing vessels to conceal their real activities and conduct illegal fishing in Hong Kong, leading to a scarcity of labeled data that are required to perform the fishing detection tasks.

### SUMMARY OF THE INVENTION

According to a first aspect of the invention, there is provided a method for detecting a vessel engaging in illegal fishing comprising the steps of:
receiving automatic identification system (AIS) data from transceivers of vessels;
preprocessing the AIS data to generate a set of motion-related features;
constructing one or more trajectory representations from the set of motion-related features;
extracting one or more features from the one or more trajectory representations with an auto-encoder module; and
selecting one or more random sample data for an Artificial Intelligence Engine for detecting a vessel engaging in fishing;
wherein the Artificial Intelligence Engine comprises an unsupervised learning module for labeling the one or more trajectory representations into a plurality of labels; and a supervised learning module for generating a machine learning model for determining the vessel engaging in illegal fishing.

In an embodiment of the first aspect, the unsupervised learning module is implemented with a K-mean clustering algorithm for classifying features from the one or more trajectory representations.

In an embodiment of the first aspect, the K-mean clustering algorithm is set to classify data into two clusters.

In an embodiment of the first aspect, one cluster is labeled as fishing, and another as sailing.

In an embodiment of the first aspect, the supervised learning module is implemented with a random tree (RF) algorithm for generating the machine learning model for determining the vessel engaging in fishing.

In an embodiment of the first aspect, the supervised learning module comprises a validation module for validating the correctness of the machine learning model.

In an embodiment of the first aspect, the supervised learning module comprises an evaluation module for evaluating the machine learning model in accordance with one or more evaluation metrics.

In an embodiment of the first aspect, the evaluation metrics comprise one or more of the following: precision, recall, F1-score, and accuracy.

In an embodiment of the first aspect, the trajectory representations comprise one or more AIS data points.

In an embodiment of the first aspect, the auto-encoder module is implemented with a convolution neural network.

In an embodiment of the first aspect, the preprocessing the AIS data comprises the step of cleaning the raw AIS dataset.

In an embodiment of the first aspect, the preprocessing the AIS data comprises the step of generating a set of motion-related features, such as recalculated speed over ground (SOG), acceleration, and change of recalculated course over ground (COG).

In an embodiment of the first aspect, the trajectory representations are constructed by combining a map of a region in Hong Kong, China and vessel trajectories formed from set of motion-related features.

In an embodiment of the first aspect, the automatic identification system (AIS) data is collected from remote sensing technology.

In an embodiment of the first aspect, the AIS data comprises one or more of Vessel Maritime Mobile Service Identity (MMSI), Navigation Status, Rate of Turn, Speed Over Ground, S spatial details (e.g., longitude and latitude), Course Over Ground, UTC seconds.

According to a second aspect of the invention, there is provided a system for detecting a vessel engaging in illegal fishing, wherein the system comprises:
one or more sensors for collecting AIS data from transceivers of vessels in real-time;
a ground station server comprises one or more central Processing Units (CPUs), Graphic Processing Units (GPUs) or Tensor Processing Units (TPUs) for tensor or multi-dimensional array calculations or manipulation operations of an artificial intelligence algorithm, read-only memory (ROM), random access memory (RAM), wherein the ground station server adapted to:
   preprocess the AIS data to generate a set of motion-related features;
   constructing one or more trajectory representations from the set of motion-related features;
   extracting one or more features from the one or more trajectory representations with an auto-encoder module; and
   selecting one or more random sample data for an Artificial Intelligence Engine for detecting vessel engaging in fishing;
wherein the Artificial Intelligence Engine comprises an unsupervised learning module for labeling the one or more trajectory representations into a plurality of labels; and a supervised learning module for generating a machine learning model for determining the vessel engaging in fishing.

In an embodiment of the first aspect, the step of preprocessing the AIS data comprises the step of removing duplicated data, generating missing AIS data, and removing abnormal data.

### BRIEF DESCRIPTION OF THE DRAWINGS

Embodiments of the present invention will now be described, by way of example, with reference to the accompanying drawings in which:

FIG. 1 is a schematic diagram of a system for detecting a vessel engaging in illegal fishing in Hong Kong China of an embodiment of the present invention.

FIG. 2 is a schematic diagram of a process implemented in the system as shown in FIG. 1.

FIG. 3 is a schematic diagram of an overall structural framework of the process for detecting a vessel engaging in illegal fishing implemented in a system as shown in FIG. 1.

FIG. 4 is a schematic diagram of a methodological workflow for the proposed AI Engine implemented in a system as shown in FIG. 1.

FIG. 5 shows a confusion matrices generated from the data collected from a system as shown in FIG. 1.

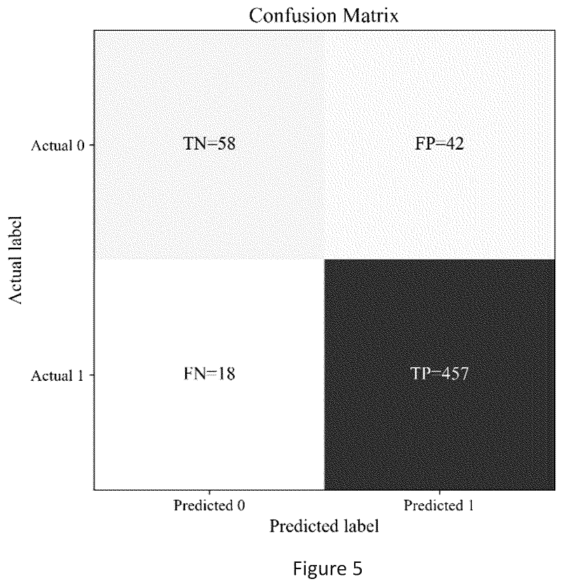

### DETAILED DESCRIPTION OF THE PREFERRED EMBODIMENT

The present invention provides an advanced and innovative semi-supervised model that leverages AIS data to detect fishing activities. The system and method of the present invention are adapted to identify whether a vessel was carrying out fishing activities or not at a given time and location, thereby assisting marine authorities in validating the vessel's qualification for fishing in Hong Kong.

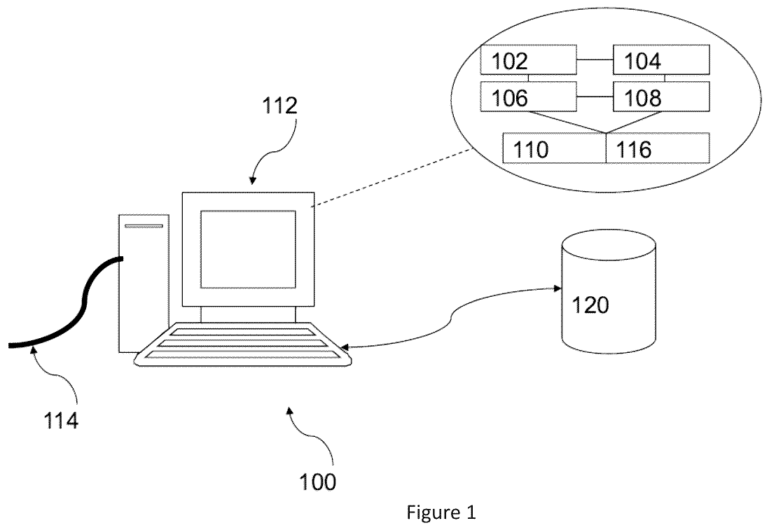

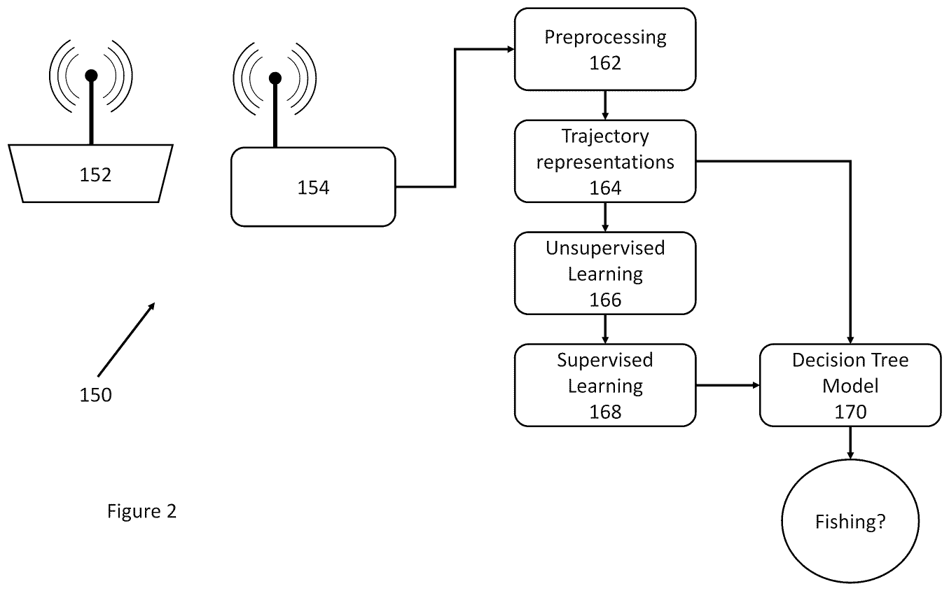

With reference to FIGS. 1 and 2, an embodiment of the present invention is illustrated. This embodiment is arranged to provide a system and method for detecting a vessel engaging in illegal fishing and in particular adapted to detecting a vessel engaging in fishing in Hong Kong, China.

In this example embodiment, the interface and processor are implemented by a computer having an appropriate user interface. The computer may be implemented by any computing architecture, including portable computers, tablet computers, stand-alone Personal Computers (PCs), smart devices, Internet of Things (IoT) devices, edge computing devices, client/server architecture, “dumb” terminal/mainframe architecture, cloud-computing based architecture, or any other appropriate architecture. The computing device may be appropriately programmed to implement the invention.

Turning first to FIG. 1, there is a shown a schematic diagram of a computer system or computer server 100 which is arranged to be implemented as an example embodiment of a system for generating a morphological atlas of an embryo. This embodiment comprises a server 100 which includes suitable components necessary to receive, store and execute appropriate computer instructions. The components may include a processing unit 102, including Central Processing Units (CPUs), Math Co-Processing Unit (Math Processor), Graphic Processing Units (GPUs) or Tensor Processing Units (TPUs) for tensor or multi-dimensional array calculations or manipulation operations, read-only memory (ROM) 104, random access memory (RAM) 106, and input/output devices such as disk drives 108, input devices 110 such as an Ethernet port, a USB port, etc. Display 112 such as a liquid crystal display, a light emitting display or any other suitable display and communications links 114 may also be present. The server 100 may include instructions that may be included in ROM 104, RAM 106 or disk drives 108 and may be executed by the processing unit 102. There may be provided a plurality of communication links 114 which may variously connect to one or more computing devices such as a server, personal computers, terminals, wireless or handheld computing devices, Internet of Things (IoT) devices, smart devices, edge computing devices. At least one of a plurality of communications link may be connected to an external computing network through a telephone line or other type of communications link.

The server 100 may also include storage devices such as a disk drive 108 which may encompass solid state drives, hard disk drives, optical drives, magnetic tape drives or remote or cloud-based storage devices. The server 100 may use a single disk drive or multiple disk drives, or a remote storage service. The server 100 may also have a suitable operating system 116 which resides on the disk drive or in the ROM of the server 100.

The computer or computing apparatus may also provide the necessary computational capabilities to operate or to interface with a machine learning network, such as a neural network, to provide various functions and outputs. The neural network may be implemented locally, or it may also be accessible or partially accessible via a server or cloud-based service. The machine learning network may also be untrained, partially trained or fully trained, and/or may also be retrained, adapted or updated over time.

FIG. 2 is a block diagram of a system 150 for detecting a vessel 152 engaging in illegal fishing. The vessel 152 is equipped with a transceiver for sending automatic identification system (AIS) data. However, it is assumed that the AIS data may be incomplete and contain defects. The ground station server 154 is equipped with sensor technology for collecting AIS data sent from the vessel 152 in real time. Preferably, the sensor technology comprises receivers for receiving images of the region. After the ground station server 154 received the AIS data, the AIS data is forwarded to the preprocessing module 162 for cleansing and standardization. The cleansed data is then used to reconstruct the trajectory representations 164 of the vessel. In the training session, the trajectory representations 164 are classified by an unsupervised learning model 166 into two categories with distinct labels. The classified data is then forwarded to a supervised learning module 168 to generate a machine learning model 170. For prediction or classification process, the trajectory representations 164 are forwarded to the machine learning model 170 to detect whether a vessel is engaging in illegal fishing.

As such, in one embodiment of the present invention, there is provided a method for detecting a vessel engaging in illegal fishing. The method comprising the steps of: receiving automatic identification system (AIS) data from transceivers of vessels; preprocessing the AIS data to generate a set of motion-related features; constructing one or more trajectory representations from the set of motion-related features; extracting one or more features from the one or more trajectory representations with an auto-encoder module; and selecting one or more random sample data for an Artificial Intelligence Engine for detecting vessel engaging illegal fishing; wherein the Artificial Intelligence Engine comprises an unsupervised learning module for labeling the one or more trajectory representations into a plurality of labels; and a supervised learning module for generating a decision tree model for determining the vessel engaging in illegal fishing.

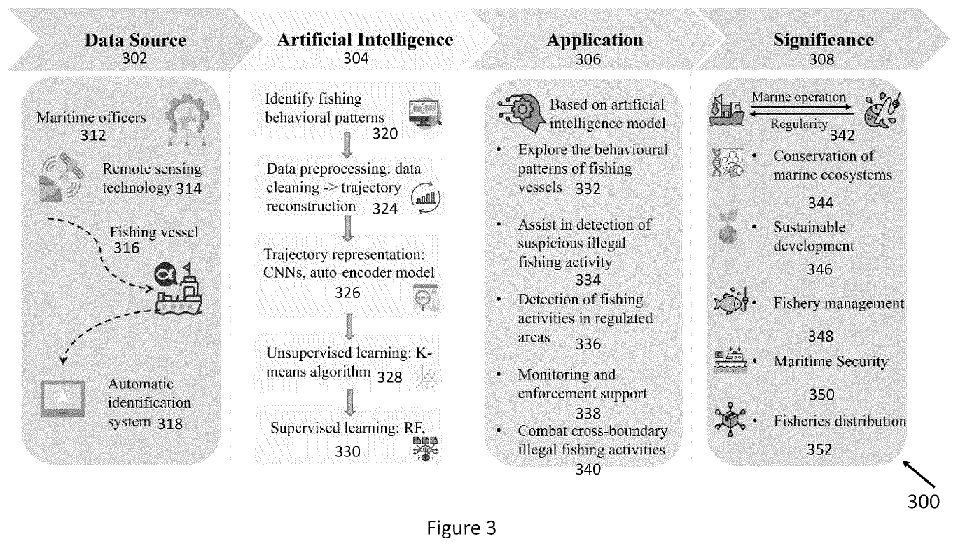

To address the challenges and the problem in the prior art, the present invention provides an advanced and innovative semi-supervised artificial intelligence system that leverages AIS data to detect fishing activities. The present invention is adapted to identify whether a vessel is carrying out fishing activities or not at a given time and location, thereby assisting marine authorities in validating the vessel's qualification for fishing in Hong Kong. Furthermore, the present invention is adapted to provide assistance to perform the resource allocation and patrol planning to combat illegal fishing more effectively. FIG. 3 depicts the overall structural framework of the artificial intelligence engine of the system of an embodiment of the present invention. FIG. 3 provides a clear roadmap for the artificial intelligence engine of the present invention.

Reference is made to FIG. 3. At a higher level of an embodiment of the present invention, the system 300 is designed to retrieve data from a diverse range of data sources 302. The data sources 302 may comprise data collected from maritime officers 312, remote sensing technology 314, fishing vessels 316, or automatic identification system (AIS) 318.

In one embodiment, Maritime Officer 312 has access to a ground station server for data collection. The ground station server is equipped with a plurality of remote sensing technology 314 or different kinds of transceivers, such as radar, Global Navigation Satellite Systems (GNSS), Alternative Position, Navigation, and Timing solutions (APNT), magnetic navigation (MAGNAV), Absolute Positioning Using the Earth's Magnetic Anomaly Field, Cellular network, Wi-Fi, Bluetooth, VHF transceivers, etc. Some of these sensors are adapted to form part of the AIS 318 for collecting short-range coastal tracking system data, which is broadcast directly by fishing vessels 316 or other nearby ships in real-time.

The data obtained from AIS may comprise Vessel Maritime Mobile Service Identity (MMSI), Navigation Status, Rate of Turn, Speed Over Ground, spatial details (e.g., longitude and latitude), Course Over Ground, UTC seconds. It is understood that the AIS data may suffer a number of problems such as missing attributes or missing data due to a number of factors, such as intentional deactivation of the AIS system by shipowners to evade tracking or adverse weather conditions impacting data transmission.

The ground station server is typically adapted to collect all the raw AIS data and process the raw AIS into meaningful and actionable information. This processed information can then be transmitted back to the vessels to support informed decision-making.

The present invention provides an artificial intelligence engine 304 adapted to process the data collected from the data sources 302. In one preferred embodiment, the artificial intelligence engine 304 in the present invention is integrated into the ground station system comprising a computer server 100 for receiving and processing data from a plurality of remote sensing technology 314 or different kinds of transceivers in real-time environment while capable of training the artificial intelligence engine 304.

The computer server 100 of an embodiment of the present invention comprises an artificial intelligence engine 304, wherein the artificial intelligence engine 304 is adapted to identify fishing behaviour patterns in step 320. In order to identify the fishing behaviour patterns, the artificial intelligence engine 304 of the present invention is adapted to carry out the steps of: preprocessing data 324, reconstructing trajectories 326, executing unsupervised learning 328 and executing supervised learning 330. In a preferred embodiment, the unsupervised learning process 328 utilizes the K-means algorithm. Additionally, the supervised learning process 330 preferably employs the Random Forest (RF) algorithm.

Based on the capabilities of artificial intelligence engine 304, the present invention is adapted to provide the Applications 306 comprising one or more of the following functionalities: exploring the behavioural patterns of fishing vessels 332, assisting in detection of suspicious illegal fishing activities 334, detecting fishing activities in regulated areas 336, providing monitoring and enforcement support 338, and addressing and combating cross-boundary illegal fishing activities 340.

The significance 308 of these applications 306 lies in their contribution to: ensuring the regularity of marine operations 342, promoting the conservation of the marine ecosystem 344, supporting sustainable development 346, enabling effective fishery management 348, and enhancing maritime security 350, and managing fisheries distributions 352.

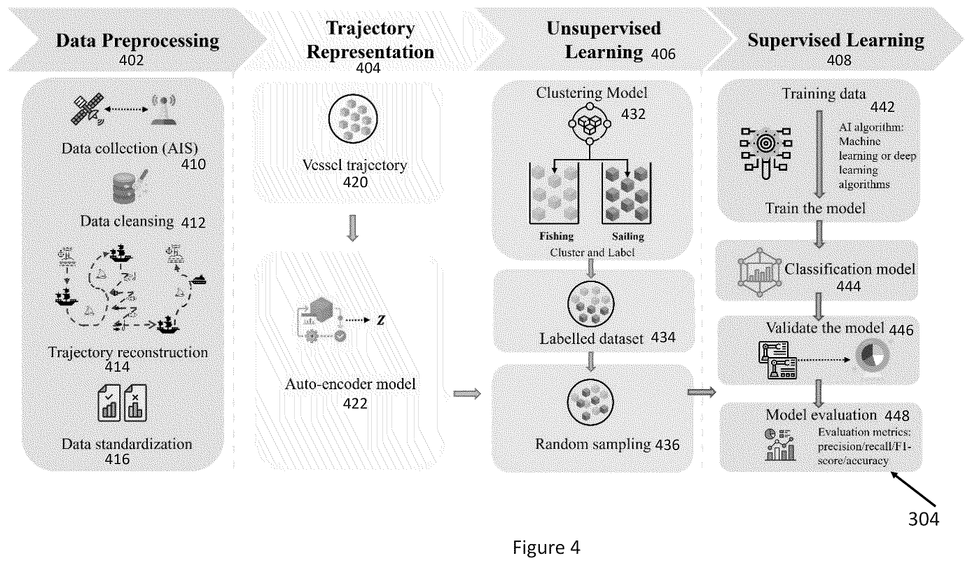

The artificial intelligence engine 304 of the present invention is designed to overcome the challenges identified in the prior art by utilizing a semi-supervised learning method. The methodological workflow is shown in FIG. 4, where two main steps are employed: (1) an unsupervised learning model to cluster and label the trajectories by their distinct features, thereby expanding the labeled dataset, followed by (2) a supervised learning model that utilizes the obtained labeled dataset to train the classifier built upon Random Forest (RF) for fishing activity detection.

Reference is now made to FIG. 4, wherein illustrated the methodological workflow for the artificial intelligence engine 304 of an embodiment of the present invention.

In artificial intelligence engine 304, there is provided a Data Preprocessing module 402 adapted to perform Data Collection module 410, Data Cleaning module 412 and Trajectory Reconstruction module 414, and Data Standardization module 416. Data Preprocessing module 402 is adapted to clean the raw dataset and reconstruct the vessel trajectory. This Data Preprocessing module 402 is adapted to generate a set of motion-related features, such as recalculated speed over ground (SOG), acceleration, and change of recalculated course over ground (COG), which are used to produce the final vessel trajectories. In one preferred embodiment, the Data Preprocessing module 402 is adapted to collect data from various data sources 302, e.g. AIS from the Data Collection module 410. In one embodiment, the Data Collection module 410 comprises an AD/DA digital signal processor (DSP) adapted to collect analog and digital signals and process the signals into digital data for further downstream processing. The raw data collected from these data sources 302 by Data Collection module 410 will be passed to the Data Cleaning module 412. The Data Cleaning module 412 will perform a number of data cleaning processes, such as removing duplicated data, filtering out of bound data, handling missing attributes, etc. The cleaned data from the Data Cleaning module 412 will be passed to the Trajectory Reconstruction Component 414 to reconstruct the trajectory of individual vessels. In one embodiment, Trajectory Reconstruction module 414. The data will be nominalized and standardized by the Data Standardization module 416 in preparation for training purposes.

The Trajectory Representation module 404 processes input data to represent vessel trajectories 420 for subsequent unsupervised learning module 406 and supervised learning module 408. This Trajectory Representation module 404 comprises a convolutional auto-encoder algorithm module 422 to extract and learn the hidden features of vessel trajectories 420. In a preferred embodiment, the vessel trajectory 420 comprises one or more images illustrating the movement patterns of vessels within a specified area. Additionally, the vessel trajectory 420 can be constructed by integrating cleaned data from the Data Preprocessing module 412 with satellite imagery. In an alternative embodiment, an AI engine is employed to identify or generate any missing data points related to vessel trajectories.

In one preferred embodiment, the auto-encoder algorithm module 422 comprises a deep learning AI system specifically designed to extract and analyze the intrinsic features embedded in the representations of vessel trajectories 420. This auto-encoder algorithm module 422 can be implemented as a convolutional neural network (CNN), leveraging its hierarchical structure to capture spatial and temporal patterns in the trajectory data. This approach enables a deeper understanding of sequential patterns and relationships within the trajectory data. Such flexibility in implementation ensures the system can adapt to varying data representations and complexities, thereby enhancing the accuracy and efficiency of feature extraction across different scenarios.

In the unsupervised learning module 406, the present invention leverages the unsupervised nature of clustering techniques 432 to group vessel trajectories 420 with similar moving behavioral characteristics into two categories (fishing and sailing) based on the derived features from Trajectory Representation and then assign labels to them.

The extracted features of the vessel trajectory 420 are forwarded to the unsupervised learning module 406 for the purpose of generating labels. In one preferred embodiment, the K-means clustering algorithm is implemented within the unsupervised learning module 406. This algorithm categorizes the data into two distinct clusters (K=2): fishing and sailing. Following this clustering process, the unsupervised learning module 406 assigns labels to the entire dataset during step 434.

Subsequently, a subset of the labeled dataset is selected through random sampling in step 436. This sampled data is then processed by the supervised learning module 408 to refine and validate the classification model, enabling more accurate predictions and classification of vessel trajectories in future analyses. This integrated approach combines the strengths of unsupervised and supervised learning techniques to enhance the system's performance and reliability.

Reference is now made to the supervised learning module 408 illustrated in FIG. 4. The randomly selected samples from the labeled dataset, generated during the unsupervised step 406, are utilized to train a classification model for detecting fishing activities. In step 442, these random samples serve as the training data for the supervised learning process.

In a preferred embodiment, an AI-based algorithm—such as a machine learning or deep learning approach—is employed to construct the classification model. In one embodiment of the present invention, the Random Forest (RF) algorithm is implemented in step 444 to generate the classification model. This algorithm leverages ensemble learning techniques to enhance the accuracy and robustness of predictions.

To ensure the reliability of the model, it is validated using an independent dataset in step 446, also selected through random sampling. The RF model's performance is then evaluated in step 448 using one or more established evaluation metrics, including precision, recall, F1-score, and accuracy. These metrics provide a comprehensive assessment of the model's effectiveness in classifying fishing activities, facilitating further refinement and optimization of the detection system.

The invention has been described in detail above for clarity and understanding of those skilled persons in the art. It is envisaged that certain modifications and adjustments can be made without departing from the core principles of the disclosure. It is important to recognize that there are alternative methods and configurations for implementing the processes and apparatuses discussed herein.

Accordingly, the embodiments described are intended to be illustrative rather than limiting. Those persons skilled in the art will appreciate that various alternations may be introduced to the described details without deviating from the fundamental principles of the invention. The scope of this disclosure should, therefore, be defined solely by the claims that follow.

1. A method for detecting a vessel engaging in fishing comprising the steps of:
receiving automatic identification system (AIS) data from transceivers of vessels;
preprocessing the AIS data to generate a set of motion-related features;
constructing one or more trajectory representations from the set of motion-related features;
extracting one or more features from the one or more trajectory representations with an auto-encoder module; and
selecting one or more random sample data for an Artificial Intelligence Engine for detecting a vessel engaging in illegal fishing;
wherein the Artificial Intelligence Engine comprises an unsupervised learning module for labeling the one or more trajectory representations into a plurality of labels; and a supervised learning module for generating a machine learning model for determining the vessel engaging in fishing.

2. The method for detecting a vessel engaging in fishing as claimed in claim 1, wherein the unsupervised learning module is implemented with a K-mean clustering algorithm for classifying features from the one or more trajectory representations.

3. The method for detecting a vessel engaging in fishing as claimed in claim 2, wherein the K-mean clustering algorithm is set to classify data into two clusters.

4. The method for detecting a vessel engaging in fishing as claimed in claim 3, wherein one cluster is labeled as fishing, and another as sailing.

5. The method for detecting a vessel engaging in fishing as claimed in claim 4, wherein the supervised learning module is implemented with a random tree (RF) algorithm for generating the machine learning model for determining the vessel engaging in illegal fishing.

6. The method for detecting a vessel engaging in fishing as claimed in claim 5, wherein the supervised learning module comprises a validation module for validating the correctness of the decision tree model.

7. The method for detecting a vessel engaging in fishing as claimed in claim 6, wherein the supervised learning module comprises an evaluation module for evaluating the machine learning model in accordance with one or more evaluation metrics.

8. The method for detecting a vessel engaging in fishing as claimed in claim 7, wherein the evaluation metrics comprise one or more of the following: precision, recall, F1-score, and accuracy.

9. The method for detecting a vessel engaging in fishing as claimed in claim 8, wherein the trajectory representations comprise one or more imagery data.

10. The method for detecting a vessel engaging in fishing as claimed in claim 9, wherein the auto-encoder module is implemented with a convolution neural network.

11. The method for detecting a vessel engaging in fishing as claimed in claim 10, wherein the preprocessing the AIS data comprises the step of cleaning the raw AIS dataset.

12. The method for detecting a vessel engaging in fishing as claimed in claim 11, wherein the preprocessing the AIS data comprises the step of generating a set of motion-related features, such as recalculated speed over ground (SOG), acceleration, and change of recalculated course over ground (COG).

13. The method for detecting a vessel engaging in fishing as claimed in claim 12, wherein the trajectory representations are constructed by combining a map of a region in Hong Kong, China and vessel trajectories formed from the set of motion-related features.

14. The method for detecting a vessel engaging in fishing as claimed in claim 13, wherein the automatic identification system (AIS) data is collected from remote sensing technology.

15. The method for detecting a vessel engaging in fishing as claimed in claim 14, wherein the remote sensing technology comprises VHF transceivers.

16. The method for detecting a vessel engaging in fishing as claimed in claim 15, wherein the AIS data comprises one or more of Vessel Maritime Mobile Service Identity (MMSI), Navigation Status, Rate of Turn, Speed Over Ground, S spatial details (e.g., longitude and latitude), Course Over Ground, UTC seconds.

17. The system for detecting a vessel engaging in illegal fishing, comprising
one or more sensors for collecting AIS data from transceivers of vessels;
a ground station server comprises one or more central Processing Units (CPUs), Graphic Processing Units (GPUs) or Tensor Processing Units (TPUs) for tensor or multi-dimensional array calculations or manipulation operations of an artificial intelligence algorithm, read-only memory (ROM), random access memory (RAM), wherein the ground station server adapted to:
preprocess the AIS data to generate a set of motion-related features;
constructing one or more trajectory representations from the set of motion-related features;
extracting one or more features from the one or more trajectory representations with an auto-encoder module; and
selecting one or more random sample data for an Artificial Intelligence Engine for detecting vessel engaging illegal fishing;
wherein the Artificial Intelligence Engine comprises an unsupervised learning module for labeling the one or more trajectory representations into a plurality of labels; and a supervised learning module for generating a machine learning model for determining the vessel engaging in illegal fishing.

18. The system for detecting a vessel engaging in illegal fishing as claim in claim 17, wherein the step of preprocessing the AIS data comprises the step of removing duplicated data, generating missing AIS data, and removing abnormal data.
